(19) United States
(12) Patent Application Publication
(10) Pub. No.: US 2004/0243707 A1
(43) Pub. Date: Dec. 2, 2004

(54) Computer firewall system and method

(76) Inventor: Gavin Watkinson, Boxford Newbury (GB)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/491,335

(22) PCT Filed: Sep. 30, 2002
(86) PCT No.: PCT/GB02/04415

(30) Foreign Application Priority Data
Oct. 1, 2001 (GB) 0123563.9

(51) Int. Cl. G06F 15/173

(52) U.S. Cl. 709/225

(57) ABSTRACT

A firewall controls connection to a network to allow the user to selectively access at least one service over the network, where the or each service requires connection resources defined by connection parameters. A user interface allows a user to select at least one service and to select to enable or disable the or each selected service. Connection parameters to be enabled or disabled are determined based on the user selection and predetermined connection parameters for the or each service. Access to the or each selected service is controlled based on the determined connection parameters.

The present invention generally relates to a computer firewall to protect a computer from unauthorized or undesired communications between the computer and a network.

With the increased use of networked communications between computers, and particularly with the prevalent use of the Internet, use of firewalls for protecting computers from unauthorized or undesired network communications has grown. A firewall can either be provided as a separate piece of hardware, or it can be provided as a software application within the computer to monitor and control network communications. A firewall typically operates on the basis of a set of rules controlling the types of communications which are allowed or disallowed. The rules define network resources which are allowed to be used for communications between the computer and the network. Typically, prior art firewalls require a user to have an in-depth knowledge of the communication resources such as communication protocols and ports, and the communication resources that are required to enable a service such as web access, e-mail, chat, or news groups, for example. In order to configure the prior art firewalls, complex rules are required to be input by a user to define the network control required. These rules are not only complex and require a significant level of understanding by the user, but also they can sometimes be conflicting. For example, when a new rule is input, this may undesirably override a previous rule.

Prior art servers are generally concerned with preventing incoming communications, e.g. from hackers, or to limit accessibility to servers. One such firewall is the firewall provided in the Microsoft XP (trade mark) operating system. The prior art servers do not address the problem of controlling outgoing communications from a computer i.e. to control access to services available over the network. It is desirable to control outgoing communications from a computer in order to protect against worms and the like that can infect a computer and transmit information from the computer without the knowledge of the computer user.

It is therefore an object of the present invention to provide a computer firewall system and method which is simpler to use, avoids the likelihood of conflicts between rules, and controls the access to services from a computer.

In accordance with a first aspect, there is provided a computer firewall system and method for controlling connection to a network to allow a user to selectively access at least one service over the network, where the or each service requires connection resources defined by connection parameters. A user interface is provided to allow a user to select at least one service and to select to enable or disable the or each selected service. Connection parameters defining connection resources to be enabled or disabled are determined based on the user selection and predetermined connection parameters for the or each service. Access to the or each selected service is controlled based on the determined connection parameters.

Thus in accordance with this aspect of the present invention, the computer firewall does not require a user to have any knowledge or understanding of connection resources, or what resources are required for a service. A user is only required to specify the service or services that they require and sets of predetermined connection parameters are used to determine the connection resources which are required to provide that service. Thus this aspect of the present invention provides a far simpler user interface to a firewall than has hitherto been provided in the prior art.

A service required by a user over the network can comprise web, e-mail, news groups, file/print sharing, netmeeting or chat. Each of these services requires a set of connection parameters in order to enable the service. These can be predetermined and stored so that a user is only required to select the service they require and not to enter or determine the connection parameters required.

In a preferred embodiment, the user interface comprises a graphical user interface displaying the name of each service to allow a user to use a pointing device to select to enable or disable each service.

In a preferred embodiment of the present invention, the computer firewall is configured by default to disable access to all services. In this way all network connections are by default blocked. The user interface allows a user to selectively enable one or more services. The connection parameters for the selected services are determined and these parameters are used to selectively open up the access available to provide the user with the desired service whilst blocking all other connection resources not required in the instigation of the service.

In one embodiment, the connection parameters comprise at least one of a port number, and a communication protocol.

To provide the user with some degree of flexibility in configuring the firewall, in one embodiment of the present invention, the user interface allows a user to select to enable one or more ports.

In an embodiment of the present invention, the firewall can also record a log of parameters associated with communication connection attempts and the log can be displayed.

In a further embodiment of the present invention, a warning of communication connection attempts can be generated and displayed to warn a user of unauthorized or undesired connection attempts.

Another aspect of the present invention provides a computer firewall system for controlling connection to a network to allow a user to limit network connection to provide only access for at least one service over the network, where the or each service requires connection resources defined by connection parameters. The user interface allows a user to select at least one service and to select to enable or disable the or each selected service to enable the user to prevent communication resources being used for anything other than one or more desired services. Connection parameters defining connection resources to be enabled or disabled are determined based on the user selection and predetermined connection and parameters for the or each service. Connection resources are controlled based on the predetermined connection parameters to enable only those connection resources required to provide access to the or each desired service.

Thus, in accordance with this aspect of the present invention, the computer firewall blocks access to all connection resources except those required to provide the desired service as selected by a user using the user interface.

The present invention can be implemented as dedicated hardware, or as a programmed processing apparatus such as a suitably programmed general purpose computer. The present invention thus encompasses computer program code for controlling a computer to carry out the firewall method. The computer program code in accordance with the present invention can be provided to any suitable processing apparatus on any suitable carrier medium. The carrier medium can comprise a transient carrier medium such as an electrical, optical, radio frequency, microwave, acoustic, or electromagnetic signal (such as a signal carried over a communications network carrying the computer code, e.g. a TCP/IP protocol signal carrying computer code over an IP network such as the Internet), or a storage medium such as a floppy disk, hard disk, CD-ROM, tape device, or solid state memory device.

Embodiments of the present invention will now be described with reference to the accompanying drawings, in which:

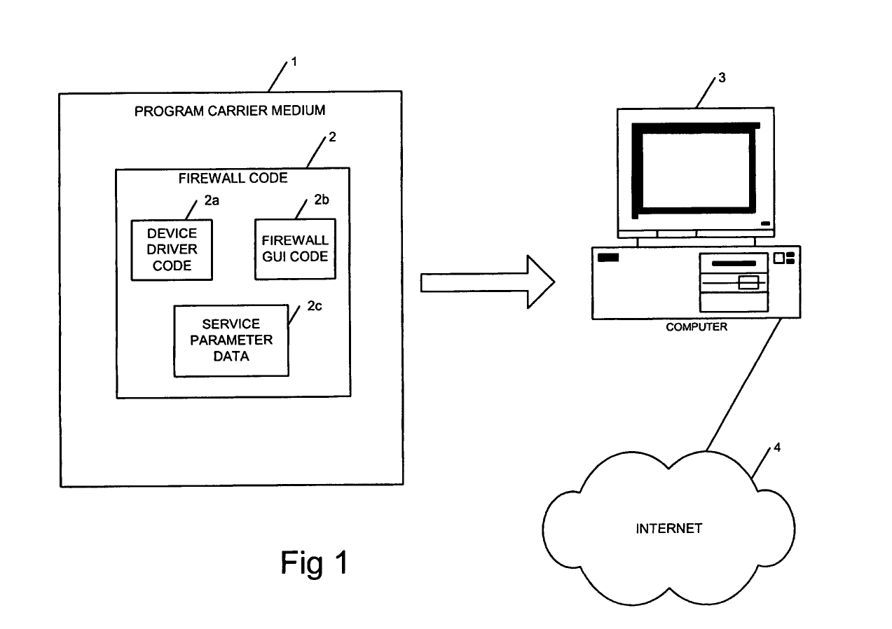

FIG. 1 is a schematic diagram of the functional components of the firewall code in accordance with an embodiment of the present invention being provided by a carrier medium to a networked computer;

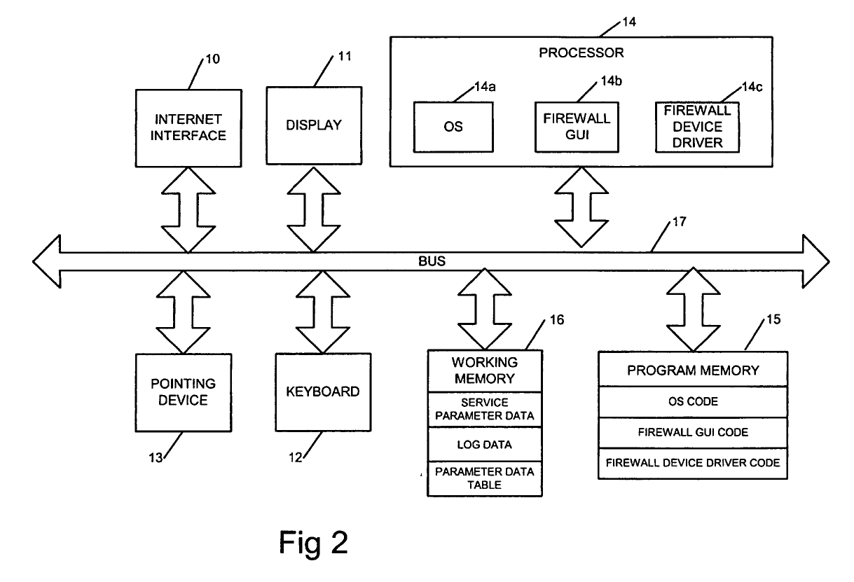

FIG. 2 is a schematic diagram of the architecture of a computer implementing the firewall code in accordance with an embodiment of the present invention;

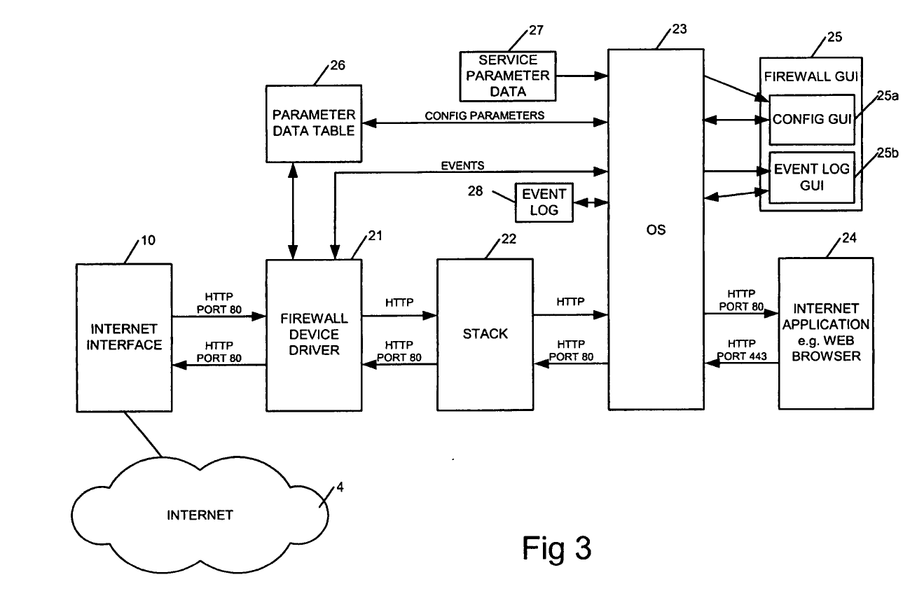

FIG. 3 is a schematic diagram illustrating the implementation of the control features of the firewall code in the computer in accordance with an embodiment of the present invention;

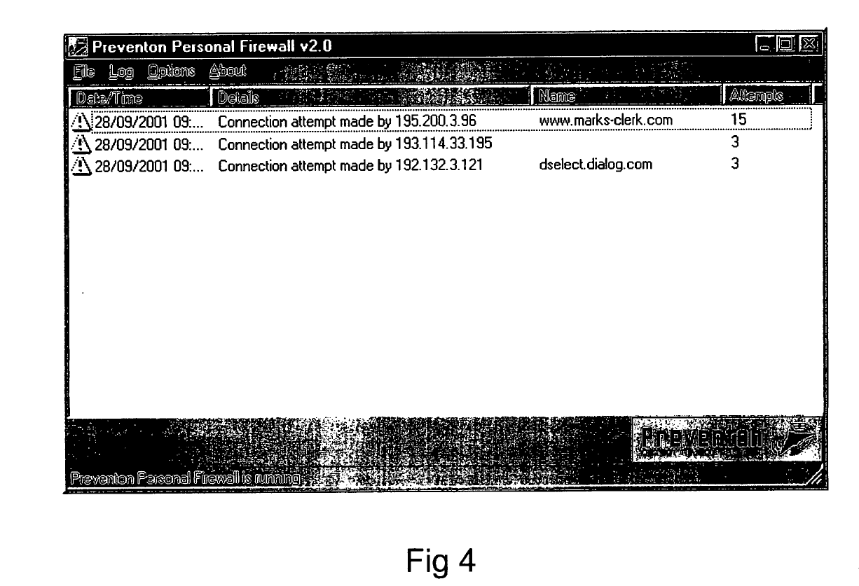

FIG. 4 is a diagram of the firewall user interface for monitoring connection attempts in accordance with an embodiment of the present invention;

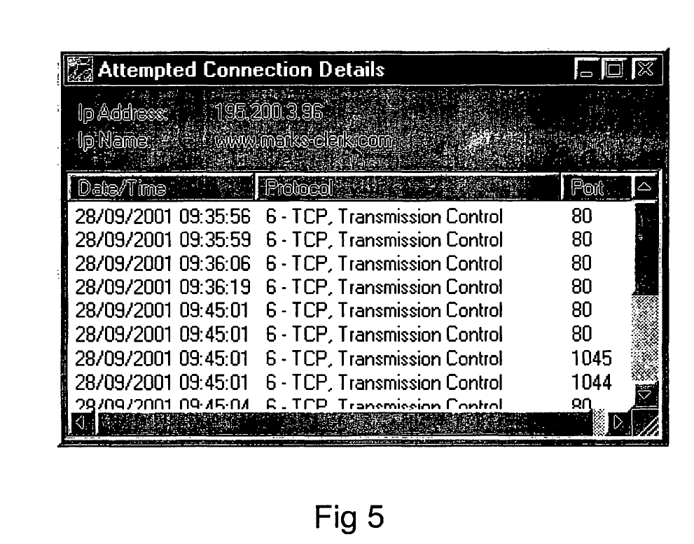

FIG. 5 is a diagram of the user interface for obtaining more information on the connection attempts in accordance with an embodiment of the present invention;

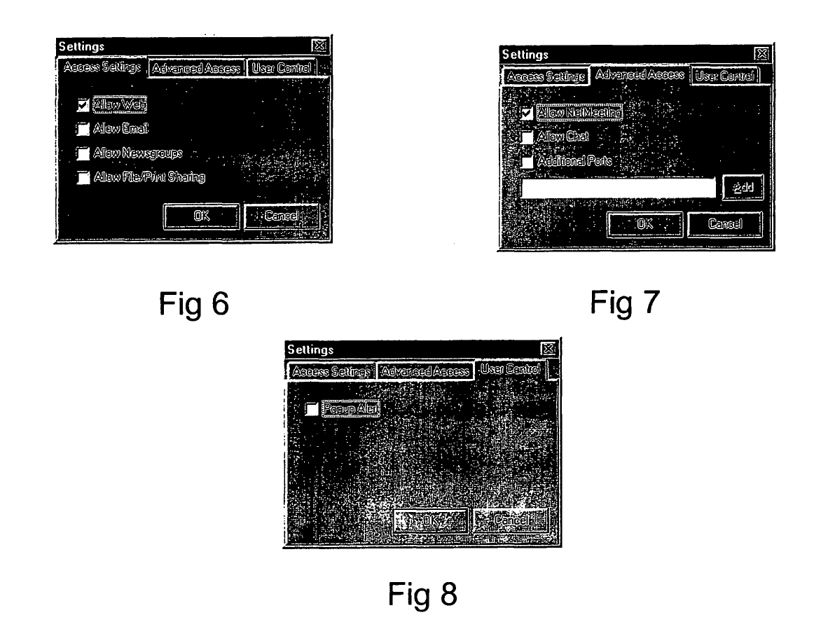

FIG. 6 is a diagram of the user interface to allow a user to selectively enable a service using the firewall in accordance with an embodiment of the present invention;

FIG. 7 is a diagram of the user interface to allow a user to selectively enable a more advanced service using the firewall of one embodiment of the present invention; and

FIG. 8 is a diagram of the user interface provided by the firewall to allow a user to select to be alerted when unauthorized and undesired connection attempts are made.

FIG. 1 illustrates the configuration of the firewall code 2 applied to a program carrier medium 1 to be applied to a computer 3 connected to the Internet 4. The program carrier medium can comprise any suitable medium for carrying the firewall code. The medium 1 can comprise a transient medium, i.e. a signal carrying the firewall code 2 which is transmitted to the computer 3 where the computer 3 can install the code for execution. The signal can comprise any physical signal such as an electrical, optical, microwave, rf, magnetic, or electromagnetic signal. For example, the carrier medium can comprise a TCP/IP signal over the Internet 4 carrying the computer code in a carrier protocol such as the file transfer protocol (FTP) or hypertext transfer protocol (HTTP). Alternatively, the program carrier medium 1 can comprise a storage medium such as a floppy disk, hard disk, CD-ROM, magnetic tape, or solid state memory device.

The firewall code 2 comprises three main components:

1. The firewall graphical user interface (GUI) code 2b which comprises the code for generating the user interface and for generating the parameter data table for use by the device driver as will be described in more detail hereinafter;

2. A device driver code 2a for performing the firewall control function in accordance with the connection parameters in the connection data table; and

3. Service parameter data 2c which comprises sets of parameter data defining connection resources required for the implementation of a service.

Although in FIG. 1 the service parameter data 2c is illustrated as being part of the firewall code 2, the service parameter data 2c need not be hard coded within the executable code. The firewall code illustrated in FIG. 2 can comprise the installation code for installing the firewall code onto the computer 3 and the service parameter data 2c can comprise a separate data file within the installation code for installing in the memory of the computer 3.

FIG. 2 is a schematic illustration of the architecture of the computer 3 following the installation of the firewall code 2. The computer 3 comprises an Internet interface 10 which can comprise a modem for dial-up access, an ADSL interface for always-on connection to the Internet, or a local area network interface such as an internet card for connection to the Internet via a local area network. A display 11 is provided to display a graphical user interface to the user. A pointing device 13 is provided to enable a user to make user selections of the services to be enabled from the displayed options on the display 11. A keyboard 12 is also provided to provide the option of keyboard input. A working memory 16 is provided as volatile memory, i.e. random access memory (RAM). The working memory stores data used during the operation of the firewall. The data used comprises the service parameter data, log data comprising a log of connection attempts, and a parameter data table comprising parameter data for the service configuration selected by the user, i.e. a subset of the service parameter data. The service parameter data is also required to be stored in non-volatile memory to ensure that it is available whenever the program is implemented. Also, the log data and the parameter data table can be stored in non-volatile memory to store a continuous log of communication attempts and to ensure that the parameter data in the parameter data table can be used every time the program is started as a default set of selected parameters to avoid the user having to reselect desired services every time the firewall program is started.

A program memory 15 is provided which, during the implementation of the code, comprises a section of the non-volatile memory. Permanent non-volatile memory (not shown) is also provided for storage of the programs when not being implemented by the processor 14. The program memory 15 stores an operating system, which in this embodiment comprises Windows 95, Windows 98, Windows ME, Windows 2000 or Windows NT. The program memory 15 also stores the firewall code as two modules, firewall GUI code and firewall device driver code. The processor 14 is provided to read and implement the code stored in the program memory 15 utilizing the data in the working memory 16. The processor reads the operating system code in the program memory 15 to implement the operating system 14a. The firewall GUI code is read by the processor 14 from the program memory 15 to implement the firewall GUI 14b. The firewall device driver code is read from the program memory 15 by the processor 14 to implement the firewall device driver 14c.

Each of the components within the computer 3 are interconnected by a data and control bus 17.

It should be noted that the schematic diagram of FIG. 2 illustrates the configuration during the implementation of the firewall code in which the code is loaded into the program memory and the service parameter data is loaded into the working memory. The program creates log data and the parameter data table as will be described in more detail hereinafter. Prior to loading the firewall code for implementation, the firewall code together with the service parameter data will reside in non-volatile memory, e.g. on the hard disk of computer 3.

FIG. 3 is a schematic diagram illustrating the implementation of the firewall in computer 3. The Internet interface 10 is connected to the Internet 4. Although in this embodiment the Internet 4 is the communications network, the present invention is applicable to any communications network. In particular, the network can comprise any network type. In this embodiment the network can be any Internet Protocol (IP) network, not just the Internet. The network can comprise an intranet, an extranet or a local area network, for example.

When the firewall code is installed in the computer 3, a firewall device driver 21 is installed to intercept all communications to and from the Internet interface 10 which comprises the physical port of the computer 3. The firewall device driver 21 intercepts communications between the Internet interface 10 and the protocol stack 22. The protocol stack 22 is controlled by the operating system 23, which in this example comprises Windows 95, Windows 98, Windows ME, Windows 2000 or Windows NT. The Internet application 24 wishing to communicate over the Internet 4 sits on top of the operating system 23 in order to set up a communication channel to the stack 22 via the firewall 21 to the Internet interface 10 to the Internet 4. In this embodiment the Internet application is a web browser and thus a web service is required to enable web browsing. Also sitting on top of the operating system 23 is the firewall GUI 25. The firewall GUI 25 provides a configuration GUI 25a to allow a user to select a service and thus configure the firewall to control communications to and from the Internet 4. The configuration GUI 25a receives user selections for services and looks up parameter data for the service in the service parameter data 27. In this way sets of parameters for the desired services can be determined and thus the configuration GUI 25a generates a parameter data table 26 defining the configuration parameters for controlling network access. The parameter data table 26 is made available by the operating system to the firewall device driver 21 which looks to the parameters in the data table to be used as the firewall rules for controlling network access.

The operation of the firewall will now be described with reference to the displays of the user interfaces of FIGS. 4 to 8.

When the firewall code is initially installed on the computer, and if during the installation process, the user does not select to enable any services, the parameter data table 26 will be empty since no services are selected. A firewall device driver 21 will thus block all communications. In this embodiment of the present invention the communications are blocked by monitoring outgoing communication attempts. In network communications, in order to set up a network communications channel, if a communication channel is requested to be set up from outside the computer, a request is made to a computer and this has to be acknowledged. In this embodiment the network is an Internet Protocol network and in this specific embodiment, all communications using a protocol other than TCP (transmission control protocol) are blocked. For example, ICMP (internet control message protocol) is blocked by the firewall device driver 21. When TCP requests are received from outside the computer requesting the setting up of a communication channel, in this embodiment the incoming requests are allowed through to the stack 22 by the firewall device driver 21 and thus onto the target application. In order to set up a TCP communication channel, it is necessary for an acknowledgement to be sent back to the requester. It is this acknowledgement which is detected by the firewall device driver 21 and blocked. Thus, since the requester does not receive an acknowledgement response, no communication channel can be set up.

Where a connection request is generated within the computer, the firewall device driver 21 can block any outgoing connection requests. Thus, in the example illustrated in FIG. 3, an attempt by an internet application, i.e. the web browser 24 to access a web page over Internet 4 will be blocked. The firewall device driver 21 detects a TCP request indicating the HTTP protocol and requesting a connection on port 80 at the target web server.

The firewall device driver 21 logs all connection attempts and the events are sent by the operating system 23 to the event log GUI 25b for storing the events in the event log 28 via the operating system 23. The event log GUI 25b can access the event log and display the events as illustrated in FIG. 4. It can be seen that in the display there were 15 attempts to connect to www.marks-clerk.com. It is possible to get more information on the connection by double clicking on the log entry to bring up the event log window illustrated in FIG. 5. Here, each individual connection attempt is logged showing the protocol and the port used for the connection attempt.

When a user wishes to enable a service, a user can select on the options menu item in the display of FIG. 4 to bring up a settings window as illustrated in FIG. 6 which comprises the configuration GUI 25a. The normal access settings of allowing web, e-mail, news groups and file/print sharing can be selected. In the example illustrated in FIG. 6 the web service has been selected as being allowed. When OK is selected, the configuration of GUI 25a accesses the service parameter data 25 to look up the connection parameters required to enable the firewall device driver 21 to allow web access. The service parameter data 27 defining the connection resources to be made available for services is given below:

| Service | Connection Resource allowed |
|---|---|
| DNS | Port 53 |
| Web | FTP on Port 20 |
| | FTP on Port 21 |
| | TELNET on Port 23 |
| | HTTP on Port 80 |
| | HTTPS on Port 443 |
| Email | POP3 on Port 110 |
| | SMTP on Port 25 |
| | IMAP on Port 143 |
| | IMAP3 on Port 220 |
| | IMAP4-SSL on Port 585 |
| | IMAPS on Port 993 |
| Newsgroup | NNTP on Port 119 |
| Netbios | Port 137, 138 and 139 |
| (file/print share) | |
| Netmeeting | Port 1503 and 1720 |
| Chat | Port 6665, 6666, 6667, 6668, 6669 and 8002 |

It can thus be seen that when a user selects to allow the web service, the following connection resources are allowed. Communications using the FTP protocol on port 21 are allowed, communications using the FTP protocol on port 20 are allowed, communications using the TELNET protocol on port 23 are allowed, communications using the HTTP protocol on port 80 are allowed, and communications using the HTTP protocol on port 443 are allowed. All other ports and protocols are blocked. Any communication channel using a TCP or UDP protocol and port not included in the list would not be allowed by the firewall device driver 21 and would be included in the event log 28.

From the example illustrated in FIG. 3, when the internet application, i.e. the web browser 24 requests a web page and the parameter data table 26 includes the connection resources allowed for the web service, the web browser 24 generates an HTTP request to connection to the target server on port 80. This is allowed through by the firewall device driver 21. In response, the target web server generates an acknowledgement and a request to the computer to connect to port 80 using the HTTP protocol. This is received by the firewall device driver 21 and stack 22 and the HTTP is passed to the web browser 24. In this way the web browser 24 receives web pages.

The configuration of GUI 25a also allows a user to select advanced access options as illustrated in FIG. 7. The advanced access options allows a user to select to allow access to the services netmeeting and chat. Further, there is an ability provided to allow a user to select to enable specific ports. This requires a user to determine the port that a specific application requires in order to operate. This may be required for certain applications which do not use any of the standard port numbers. For example, online games use a variety of port numbers. Doom, for example, uses port 6000. The service parameter data 27 listed above lists the connection resources allowed for the netmeeting and chat services.

The configuration GUI 25a also allows a user to select to be warned of connection attempts. FIG. 8 illustrates the ability to select “pop-up alert”. When this is selected, whenever a connection attempt is made which is blocked by the firewall device driver 21, a warning window is displayed to warn the user of a failed connection attempt.

Although the present invention has been described hereinabove with reference to specific embodiments, it will be apparent to a skilled person in the art that modifications lie within the spirit and scope of the present invention.

Although in the embodiment described with reference to the drawings, the firewall device driver by default blocks all connection communications unless a service has been selected, i.e. until parameters are provided in the parameter data table 26, negative logic can be applied whereby the firewall device driver 21 allows all communications and therefore all services unless a user selects to disable a service whereupon the data entered in the parameter data table 26 defines communication resources to be blocked (not communication resources to be allowed).

Although the embodiment of the present invention has been described with reference to the Internet, the present invention is applicable to any communications network such as an Internet Protocol network, e.g. an intranet, an extranet or a local area network. Hence the protocol defined in the communication parameters for a service can comprise any network protocol. The present invention is applicable to IP protocols such as TCP, UDP and ICMP, and for non-IP protocols such as Appletalk and IPX.

The present invention can also be used to control voice communications over a network, e.g. Voice over IP (VoIP).

Although the embodiment of the present invention controls communications by controlling outgoing communication messages using the parameter data table, the present invention can be implemented by monitoring either direction or both directions.

Further, although the present invention has been described with reference to an embodiment implemented in software, the present invention is equally applicable to a hardware implemented firewall, e.g. a firewall provided as a separate piece of hardware, in which the present invention provides a more user-friendly, simple user interface for the configuration of the firewall. Thus the firewall can comprise hardware which is separate to a computer that it is protecting, or it can be integrated within the computer being protected. Further, the firewall can be implemented in software or hardware.

Although the embodiments of the present invention define specific connection resources defined by connection parameters, the present invention is applicable to any parameters defining connection resources required to facilitate a service between a computer and a communications network.

1. A computer firewall system for controlling connection to a network to allow a user to selectively access at least one service over the network, where the or each service requires connection parameters, the computer firewall system comprising:
a user interface means for allowing a user to select at least one service and to select to enable or disable the or each selected service;
connection parameter determining means for determining connection parameters to be enabled or disabled based on the user selection and predetermined connection parameters for the or each service; and
control means for controlling access to the or each selected service based on said determined connection parameters.

2. A computer firewall system according to claim 1, wherein said at least one service consists of at least one of web, email, newsgroup, file/print sharing, netmeeting, or chat.

3. A computer firewall system according to claim 1, wherein said user interface means is adapted to generate a graphical user interface displaying the name of the or each service to allow a user to use a pointing device to select to enable or disable the or each service.

4. A computer firewall system according to claim 1, including a service parameter data store storing the predetermined connection parameters for the or each service, wherein said connection parameter determining means is adapted to read the predetermined connection parameters in the service parameter data store for the or each selected service as said determined connection parameters.

5. A computer firewall system according to claim 1, wherein said control means is adapted to, by default, disable access to all services, said user interface means is adapted to allow a user to select to enable at least one service, said connection parameter determining means is adapted to determine the connection parameters to be enabled based on the user selection and said predetermined connection parameters for the or each service, and said control means is adapted to allow access to the or each selected service based on said determined connection parameters.

6. A computer firewall system according to claim 1, wherein said control means comprises a device drive to control connections to a protocol stack.

7. A computer firewall system according to claim 1, wherein said connection parameters comprise at least one of port number and communication protocol.

8. A computer firewall system according to claim 1, wherein said user interface means is adapted to also allow a user to select to enable one or more ports, and said control means is adapted to be responsive to the user selection to enable the or each selected port.

9. A computer firewall system according to claim 1, including connection log means for recording parameters associated with communication connection attempts and for displaying the recorded parameters.

10. A computer firewall system according to claim 1, including connection attempt warning means for generating and displaying a warning of communication connection attempts.

11. A method of controlling connection of a computer to a network to allow a user of the computer to selectively access at least one service over a network, where the or each service requires connection parameters, the method comprising:
receiving a user selection identifying at least one service and whether the selected service is to be enabled or disabled;
determining connection parameters to be enabled or disabled based on the user selection and predetermined connection parameters for the or each service; and
controlling access to the or each selected service based on said determined connection parameters.

12. A method according to claim 11, wherein said at least one service consists of at least one of web, email, newsgroup, file/print sharing, netmeeting, or chat.

13. A method according to claim 11, wherein a graphical user interface is generated displaying the name of the or each service to allow a user to use a pointing device to select to enable or disable the or each service.

14. A method according to claim 11, including storing the predetermined connection parameters for the or each service, and reading the stored predetermined connection parameters for the or each selected service as said determined connection parameters.

15. A method according to claim 11, wherein, by default, access to all services is disabled, a user selection to enable at least one service is received, the connection parameters to be enabled are determined based on the user selection and said predetermined connection parameters for the or each service, and access to the or each selected service is allowed based on said determined connection parameters.

16. A method according to claim 11, wherein the access control is performed by a device drive to control connections to a protocol stack.

17. A method according to claim 11, wherein said connection parameters comprise at least one of port number and communication protocol.

18. A method according claim 11, wherein the received user selection includes a selection to enable one or more ports, and the selected ports are enabled or disabled in accordance with the user selection.

19. A method according claim 11, including recording parameters associated with communication connection attempts and displaying the recorded parameters.

20. A method according to claim 11, including generating and displaying a warning of communication connection attempts.

21. A computer firewall system for controlling connection to a network to allow a user to selectively access at least one service over a network, where the or each service requires connection parameters, the computer firewall system comprising:
a program memory storing processor readable instruction code for controlling a processor; and
a processor for reading and implementing the instruction code in the program memory;
wherein the processor readable code in the program memory comprises code implementable by the processor to carry out the method of any one of claims 11 to 20.

22. A computer firewall system for controlling connection to a network to allow a user to limit network connection to provide only for access to at least one service over the network, where the or each service requires connection resources defined by connection parameters, the computer firewall system comprising:
a user interface means for allowing a user to select at least one service and to select to enable or disable the or each selected service to enable the user to prevent communication resources being used for anything other than one or more desired services;
connection parameter determining means for determining connection parameters defining connection resources to be enabled or disabled based on the user selection and predetermined connection parameters for the or each service; and
control means for controlling connection resources based on said determined connection parameters to enable only those connection resources required to provide access to the or each desired service.

23. A computer firewall system according to claim 22, wherein said control means is adapted to, by default, disable all network connections and access to all services, said user interface means is adapted to allow a user to select to enable at least one service, said connection parameter determining means is adapted to determine the connection parameters defining connection resources to be enabled based on the user selection and said predetermined connection parameters for the or each service, and said control means is adapted to only enable the connection resources required to allow access to the or each selected service based on said determined connection parameters.

24. A method of controlling connection of a computer to a network to allow a user to limit network connection to provide only for access at least one service over the network, where the or each service requires connection resources define by connection parameters, the method comprising:
receiving a user selection identifying at least one service and whether to enable or disable the or each selected service to enable the user to prevent communication resource being used for anything other than one or more desired services;
determining connection parameters defining connection resources to be enabled or disabled based on the user selection and predetermined connection parameters for the or each service; and
controlling connection resources based on said determined connection parameters to enable only those connection resources required to provide access to the or each desired service.

25. A method according to claim 24, wherein, by default, all network connections and access to all services is disabled, a user selection to enable at least one service is received, the connection parameters defining connection resources to be enabled are determined based on the user selection and said predetermined connection parameters for the or each service, and only the connection resources required to allow access to the or each selected service are enabled based on said determined connection parameters.

26. A computer firewall system for controlling connection to a network to allow a user to limit network connection to provide only for access at least one service over the network, where the or each service requires connection resources define by connection parameters, the computer firewall system comprising:
a program memory storing processor readable instruction code for controlling a processor; and
a processor for reading and implementing the instruction code in the program memory;
wherein the processor readable code in the program memory comprises code implementable by the processor to carry out the method of claim 24.

27. A carrier medium carrying computer readable code for controlling a computer to implement the method of claim 11.

28. A carrier medium carrying computer readable code for controlling a computer to implement the method of claim 24.
